(19) United States
(12) Patent Application Publication
(10) Pub. No.: US 2005/0190987 A1
(43) Pub. Date: Sep. 1, 2005

(54) Shaped blurring of images for improved localization of point energy radiators

(75) Inventor: Waldean A. Schulz, Boulder, CO (US)

Correspondence Address: WALDEAN A. SCHULZ, 1919 FOURTEENTH STREET, SUITE 500, BOULDER, CO, 80302, US

(73) Assignee: Conceptual Assets, Inc., Boulder, CO (US)

(21) Appl. No.: 10/788,593

(22) Filed: Feb. 27, 2004

(51) Int. Cl. G06K 9/36

(52) U.S. Cl. 382/291

(57) ABSTRACT

The method of this invention, and any apparatus which implements it, improves the accuracy of determining the sub-pixel location of the image of a point-like radiator of energy (typically light). This method distributes the image of a point radiator of energy over detector pixels such that the number of image pixels with high intensity gradients is maximized, while it minimizes the energy wasted on pixels with low intensity gradients, which contribute little to the computation of the sub-pixel location of the image. By improving such accuracy in each of one or more cameras, the accuracy of deriving the spatial location of the energy radiator improves also.

### CROSS-REFERENCE TO RELATED APPLICATIONS

not applicable

### FEDERALLY SPONSORED RESEARCH

not applicable

### SEQUENCE OR PROGRAM LISTING

not applicable

### FIELD OF INVENTION

This invention relates to an improvement relating to a metrology system which determines the location of at least one point-like radiator of energy in a coordinate space using one or more digital or video cameras or other such imaging sensors which employ 2-dimensional arrays of pixels.

### BACKGROUND

Generally in photography and in machine vision, one wants the sharpest image of a subject possible within hardware cost and feasibility constraints for a (digital or video) camera. A poorly focused or intentionally blurred image is considered undesirable, except perhaps for artistic purposes. Sharp focus usually requires a precision multi-element lens. For imaging and tracking radiators within a large 3-dimensional volume we also seemingly would desire good focus within a large depth of field. However, sharp focus over a larger depth of field requires the smallest aperture (largest “f/stop number”) allowed by the lighting and exposure time constraints. Smaller apertures have the disadvantage of decreasing the intensity of the image (thereby lowering the signal-to-noise ratio) and of increasing the effects of diffraction.

It may therefore seem counter-intuitive that poorer focus might improve the determination of the location of the image of a point-like radiator. However, a well-focused video camera ideally will image a tiny (“point”) radiator of light to a spot so small that it potentially can fall entirely within a single pixel. This is ideal for most imaging purposes, but all the information available to determine the image's location within that pixel has been lost. (Of course, the image is never an infinitesimally small point because of diffraction, the point spread function, and various lens anomalies.) When such a tiny image falls on the border between two adjacent pixels, it is possible to interpolate its precise sub-pixel position along the line between the centers of the two pixels. (This does assume that the two pixels have exactly the same sensitivity, which seldom happens. Note also that linear interpolation does not correctly identify the location of the center of a typically circular image divided across the two pixels.) However, in this situation there is no sub-pixel information about its position perpendicular to that interpolation line. Therefore, for sub-pixel measurement purposes, we want the image of a point radiator to fall on at least three non-collinear pixels. Preferably, we would like it to fall on many more pixels, so that any inequity of individual pixel responsivity will average out statistically.

One way to accomplish this is to use a (video or digital) camera with a high resolution: a pixel count of millions of pixels so that even a finely focused (diffraction limited) image of a point radiator always covers multiple pixels. Besides the higher cost of such a camera, the high pixel count normally increases the time to find and process the image, and therefore it reduces system throughput. Remember also that the pixel count (and memory requirements) increases with the product of the resolution in each dimension of the 2-dimensional pixel array inside the camera. So, assuming that one were to double the resolution in both dimensions, one would expect a four-fold increase in the memory and time requirements to process the image.

Some image enhancement systems, such as U.S. Pat. No. 4,517,599 and typical correlation kernel filters, attempt to enhance the image at the pixel level, which assumes that a pixel is smaller than the blur due to the point spread function (diffraction) or other source of blurring. Such correlation filtering by itself is only effective at the pixel level, and is not intended for sub-pixel localization. This might be okay if the resolution is high enough to meet accuracy requirements for localizing the image, but it requires a more expensive pixel array and uses much more computation time and data memory than is necessary for the present invention.

There is another way to insure that the image always covers at least several pixels of a less expensive, lower resolution camera. That involves intentionally defocusing the image by some means—such as an out-of-focus lens, an imperfect lens with intentional aberrations, or a softening filter such as used in portrait photography. The resultant image is shown in FIG. 1 (prior art). In any such case, the sub-pixel location of the image on the pixel array is typically determined by computing its two-dimensional centroid of the intensity over all the pixels on which the image falls.

The aforementioned means for introducing blur are not necessarily preferable. For example, if the traditional circular aperture is simply enlarged, the depth-of-field is reduced, reducing the distance range over which the system is useful. Furthermore, there is a trade-off between increasing the number of pixels on which the image falls versus maximizing the gradient across the image—especially at its periphery where the gradient is usually steepest. A steeper gradient usually involves fewer pixels, but a steeper gradient contains better information about the sub-pixel location of (the centroid of) the image within a pixel.

Alternative to introducing blur artificially, each radiator of energy can be made large—not at all tiny or point-like. This is typically done in prior art which uses retro-reflective radiators—such as the 1 centimeter diameter balls used with the Northern Digital Polaris system (Waterloo, Ontario, Canada). FIG. 2 (prior art) shows such an image, which basically would provide an image similar to the defocused image of a point radiator in FIG. 1. The location of the image is typically defined to be the intensity centroid of those pixels which contain the image. The disadvantage of the large retro-reflective radiator is that the centroid is affected by non-uniform reflectivity from the parts of the radiator—perhaps because of dirt, stains, oil, or liquids accumulated on the radiator. Non-uniform lighting or non-uniform material characteristics may also affect the sub-pixel accuracy of the centroid. Alternatives to using the centroid suffer the a similar problem—such as determining the center of the best-fit circle matched with the boundary of the image.

FIG. 3 (prior art) illustrates a conventional optical aperture, which is circular (or approximately so) and consists of a single hole or transparent area within an otherwise opaque mask. Typically the aperture is located between two of the several individual lenses in the optical path of a digital or video camera. The placement of the aperture is approximately where it has the least effect on vignetting.

In consideration of the above observations, the present invention proposes shaped apertures or even apertures with multiple transparent areas. Such apertures by themselves appear in prior art. For example, U.S. Pat. Nos. 4,645,347 and 6,278,847 and 6,580,557 employ two or more conventional, circular openings as a means of producing stereographic imaging with one lens system. U.S. Pat. No. 5,648,877 uses an elongated aperture for a line scan camera with a linear CCD to maintain depth of field in one dimension while increasing exposure. U.S. Pat. No. 4,645,347 even proposes an annular aperture. However, these are not employed for the same purpose as the present invention.

Two-dimensional multiple pin-hole apertures or two-dimensional coded apertures (such as those as referenced in U.S. Pat. Nos. 5,502,568 and 6,141,104) have been used in x-ray imaging and in astronomy. In those cases, the objective was normal scene-based imaging—not a determination of the sub-pixel location of a point-like radiator of energy. However, to recover the scene, intense computation (2-d correlations or Fourier transforms) are required, and the recovered image of a point energy radiator might not necessarily have the desired characteristics for recovery of accurate, sub-pixel positional information. U.S. Pat. No. 6,141,104 employs a coded-aperture with multiple transparent areas (albeit in one dimension only) for sub-pixel localization of an image and therefore the location of the radiator itself. Unfortunately, intense computation involved-particularly for two dimensional pixel arrays-limits the throughput speed.

Other, related prior art includes photographic special effects filters, which are used to soften portraits or produce aesthetic starburst effects around points of light in night photos. (These can be found in most camera accessory catalogs.) These of course are not intended for sub-pixel localization purposes. Diffraction gratings are also sometimes used to generate such effects.

Within this specification, a monochrome camera is being assumed without loss of generality, because color is not essential to the discussion. Furthermore, visible light energy will be assumed herein, although invisible wavelengths could be used instead. For example, an infrared (or x-ray) camera might be most appropriate for applications needing to track an infrared (or x-ray) radiator. The techniques herein might also be applied to any other energy radiators which can be imaged.

### OBJECTS AND ADVANTAGES

The first object of this invention is to provide or improve sub-pixel accuracy in the determination of the 2-dimensional location of the image of a tiny, point-like radiator of energy using controlled blurring of an image of a point source and using image processing to compute the location of the image on an array of detector pixels to a precision of finer than simply the nearest pixel. Typically the energy would be visible or infrared light. The pixel detector array would be a conventional CCD or CMOS pixel array like that inside a video camera or digital camera. The light might be actively generated from electric energy provided to an incandescent bulb or a light-emitting diode, or the energy radiator might passively reflect or diffuse energy of the same type supplied from elsewhere.

A second object is to accomplish the first object in a way that is particularly optimized for the recognition of the individual images of bright, point-like radiators of energy within the whole image on the pixel array of a camera having such a non-standard aperture. It is not necessarily an object to optimize the recognition or localization of images of any other feature in the field of view.

The third object, dependent on the first and second, is this: to determine the precise spatial location of a point radiator of energy in a global coordinate system, using one or more cameras with non-standard apertures, each camera in known relationship to the global coordinate system. The 3-d XYZ coordinates of the location of the point radiator within the global coordinate system can be numerically computed, if the numeric XY coordinates of the image's (sub-pixel) centroid on each of two pixel arrays are input into an electronic computer with appropriate software and calibration data. (Such techniques are well known in the field of optical metrology).

The fourth object, dependent on the second, is to track a rigid body within a volume as follows: Given a plurality of such point radiators appropriately arranged on a body at known locations relative to a local coordinate system local to the body, and given the ability to compute the global XYZ coordinates of each radiator, then determine the location and orientation of the body itself within the global coordinate system. (Without detracting from the present invention, we herein assume that the body is rigid; however, with enough radiators attached, the shape of a non-rigid body could also be ascertained.) The body might optionally comprise a pointing tip, some kind of end effector, or other prominent points or axes of interest to be located relative to the global system coordinate system. Furthermore, there might be more than one such body, and we might want to track the relative relationship of one body to another body dynamically.

A fifth, but minor, object is to accomplish the above without degrading the image so much that it is ineffectual for a user to observe the complete image of the overall scene on a video monitor or to provide a way to temporarily provide a clear image. This object would provide a desirable way of aiming the camera or set of cameras toward the center of the desired volume of interest.

The principal advantage of a system satisfying these objects would be enhanced accuracy in computing the location of point-like radiators or the location and orientation of bodies to which they are attached.

### SUMMARY OF THE INVENTION

To accomplish precise localization of the image of a tiny, point-like radiator of energy on a pixel array (such as a CCD or CMOS imager), the present invention employs a non-standard aperture shape or perhaps an aperture with more than one transparent area. This is unlike a standard photographic or video camera lens aperture, which conventionally approximates a single circular opening. The intent is to try to achieve two seemingly contradictory goals: (1) to project the radiator's energy onto a limited number pixels in order to maintain reasonable high signal-to-noise ratios on the pixels, and (2) at the same time to maximize the number of those pixels which have a high gradient of intensity, and which are normally found on the edge or perimeter of the image.

In effect, instead of creating a tiny well-focused spot as in a conventional camera, the shaped aperture (or equivalent diffraction filters) will blur the image somewhat along at least one line (or even a curved arc). That is, the non-standard optics defocuses the image into a non-circular shape, which may consist of several narrow but elongated lineal segments.

Hence, compared to a typical circularly-blurred spot, the image of this invention is concentrated onto fewer pixels—producing a higher signal-to-noise ratio per pixel. Yet the edge of the image is projected onto more pixels than a typical well-focused image—minimizing individual effects of pixel non-homogeneity and insuring a more accurate sub-pixel centroid. At the same time, the gradient perpendicular to the direction(s) of “smear” or blur remains high—insuring that most or all pixels significantly contribute to the centroid computation in that direction. This is accomplished by generating an image that purposefully maximizes the ratio of its perimeter to its area.

Notice that under the proper conditions this would even allow us to use pixels somewhat larger than the normal point spread function of an conventional aperture, so that we will be able to obtain subpixel accuracy with a lower resolution pixel array. The required condition is that the image blur crosses sufficient pixels and cannot ever be contained entirely within just a single row or column of pixels.

If the image of a point-like radiator is thus smeared in at least two substantially different directions, then the centroid can be very accurately computed two-dimensionally. Therefore, given a more accurate two-dimensional centroid on each of at least two sensors at accurately calibrated global locations, then more accurate global three-dimensional XYZ coordinates can be computed to locate the radiator itself in space.

Specialized image processing, rather than just straightforward centroid computation will be used to compute the sub-pixel location of the smeared image of a point radiator on the pixel array.

### DESCRIPTION OF THE DRAWINGS

The accompanying drawings, which are incorporated herein and form a part of the specification, illustrate a preferred embodiment of the present invention and, together with the description, serve to explain the principle of the invention.

FIG. 1 is an example of prior art in which the image of a point radiator of energy (such as visible or infrared light) on a portion of the pixels of a 2-dimensional pixel array, where the image was created by slightly defocusing the lens.

FIG. 2 is an example of prior art in which shows the well-focused image of a relatively larger radiator of energy (including, for example, a large retro-reflective ball illuminated by energy coming from near the camera).

FIG. 3 is an example of a prior-art circular aperture, similar to those used in photography or video cameras.

FIG. 4 depicts a non-standard aperture which lets through about the same amount of energy as the standard aperture in FIG. 3, but the non-standard aperture (preferably in conjunction with appropriate blurring lenses) shapes the image to more desirable properties for the purposes of image location determination.

FIG. 5 depicts an alternative aperture which has an annular transparency with about the same area as FIG. 3 and forms an annular image of a point source of light, but it approximately quadruples the number of pixels on which the high-gradient edges of the image falls.

FIG. 6 shows that there are further possibilities for non-standard apertures fitting the requirements of this invention. It shows a case where there is more than one transparent area in the aperture.

FIG. 7 is a simplified perspective drawing of a non-standard camera including exemplary light rays 10 from a point source of light (not shown), a particular shaped aperture 12, an optical focusing system 14, an array of detectors 16 consisting of pixels 18, and the image 20 of a point source of light as generated by the present invention. In practice, there would actually be more than one lens 14, and the aperture mask would be positioned between two of the lenses.

FIG. 8 graphs a central cross-section of the image 20 of a point radiator when using the prior-art aperture of FIG. 3. (For example, it may be the middle horizontal row of pixels across the image). We assume that the image has already been defocused so that it falls across a number of pixels each of which outputs a voltage proportional to the total intensity 22 of light falling on the area of the pixel. (The edges of the image would not be as distinct as shown in the figure.)

FIG. 9 is similar to FIG. 8, but it graphs the intensity of the image 20 along a line across the shaped image of a point radiator when using the aperture of FIG. 4, 5, or 6. The graph is for a horizontal row of pixels halfway between the center of the image and the very bottom of the image.

FIG. 10 depicts an example of a image processing correlation kernel that might be used to help find and localize the smeared image.

### DETAILED DESCRIPTION OF A PREFERRED EMBODIMENT

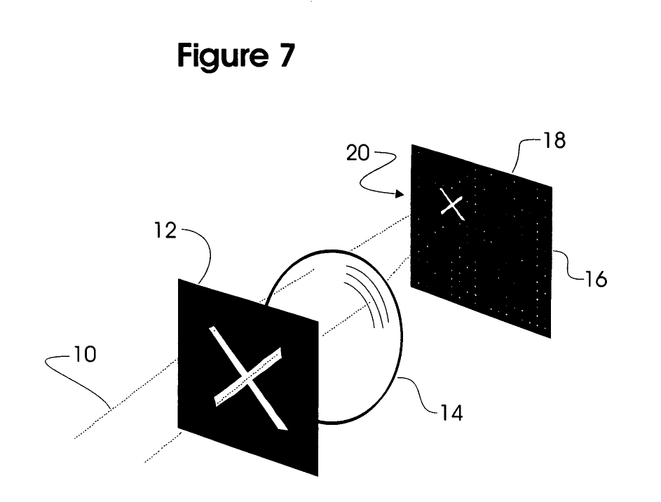

The invention in many respects is similar to a standard digital or video camera—one or more of which are part of a metrology system accurately determining the location(s) of one or more tiny radiators of light (or other energy). Multiple such energy radiators attached to a (rigid) body can then be used to track the location and orientation of the body or of distinguished parts or points of the body—preferably in real time. The present invention provides an improvement to such a system. The invention's principal elements are depicted in the simplified perspective drawing of FIG. 7.

The invention according to the preferred embodiment uses a aperture 12 such as one of those shown in FIGS. 4 through 7 and preferably uses a lens system 14 which introduces a controlled amount of blur or consistent aberration into the image 20 of a point radiator of energy. This blurring may be accomplished simply by focusing the lens for a distance nearer than the volume in which the point radiator is to be found. (Nearer is better than farther, because as the radiator approaches the camera, its image would be likely to increase in size anyway—except that the improving focus will tend to offset that increase. So, the image size will tend to be more constant irrespective of the distance of the radiator.) Alternatively, and preferably, the optics 14 is specifically engineered to introduce a controlled amount of blur. The means of introducing the blur could comprise an intentionally aberrant system of lenses, a very weak frosted surface texture on an optical surface, a specially designed interference or holographic filter, or a combination thereof. Nevertheless, it is preferable to design the system to reduce the non-linear distortion or to provide only distortion that can be corrected readily by calibration software.

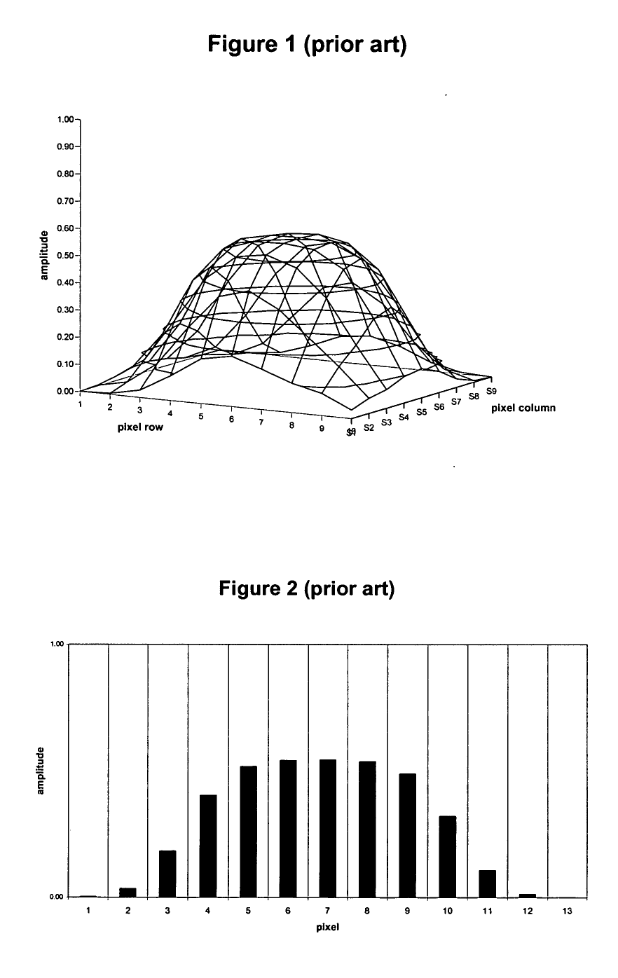

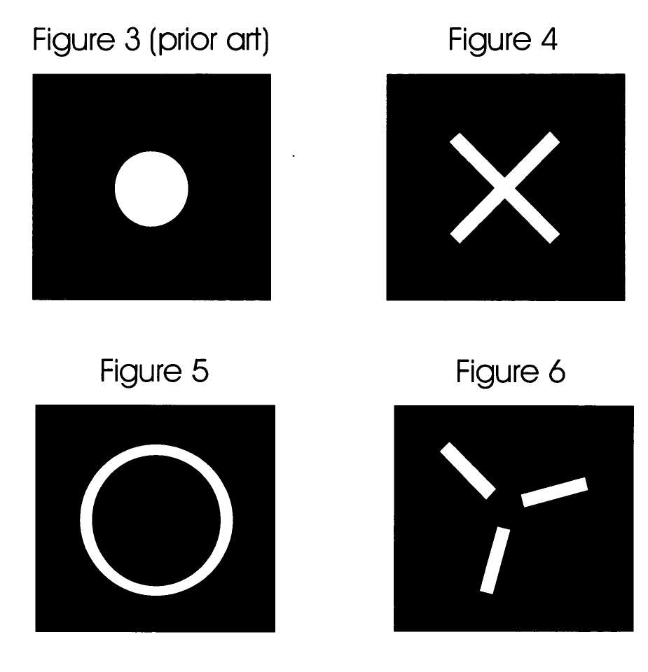

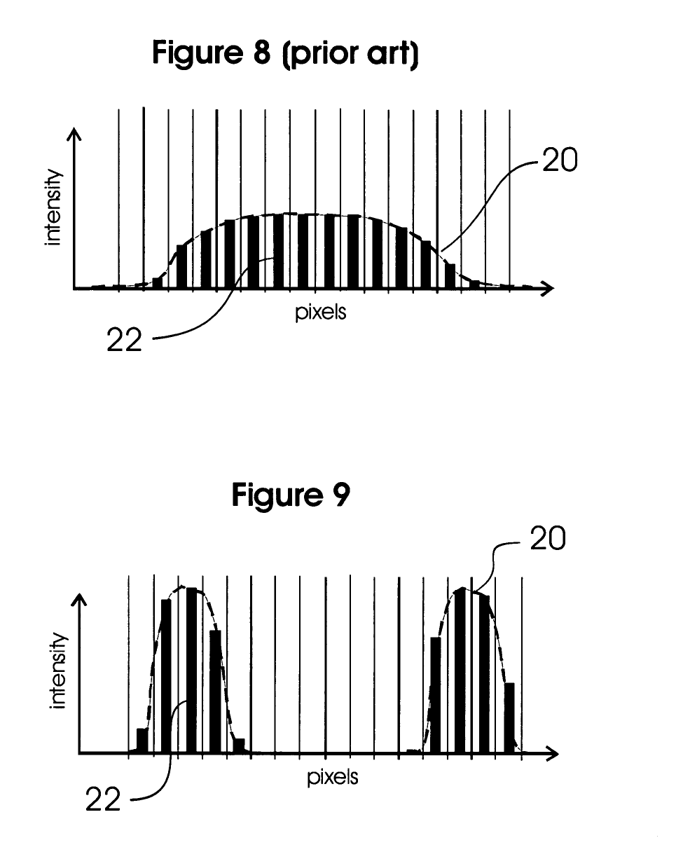

Note that in the usual image of prior art, such as in FIG. 1 or 2, the interior pixels of the image have low pixel-to pixel gradients, especially if the image were larger. Therefore, they contribute little information useful for determining the sub-pixel center of the image, yet they “waste” much of the energy impinging on the pixel array. The peripheral pixels on the fringe of the image contribute the most information. The graph in FIG. 8 illustrates this better.

Because a circle has the minimum perimeter (circumference) of any 2-d shape of a given area, it is the least attractive shape for the image for the purposes of the present invention. Note also that as a circle is increased in size, its area increases proportional to the square, but the perimeter increases only linearly. So a larger circular image will spread the incoming illumination over a rapidly increasing area. In other words, the illumination per pixel (and therefore the signal-to-noise ratio) is inversely related to the square of the diameter of the circular image for a fixed amount of total incoming light.

Therefore, a more desirable image shape should possess a significantly larger perimeter than the circumference of a circle, but with the same area as the circle. The intensity gradient is highest near the edges of the image (and is perpendicular to the edge), so we still want the edges to fall on numerous pixels. Yet, we want to restrict the area of the interior of the image (and therefore reduce or eliminate the number of pixels where the intensity gradient is low). In other words, we want to minimize the number of pixels which absorb light energy but contribute little or no information useful for sub-pixel location determination. Therefore, we would prefer images which approximate shapes such as those shown in FIGS. 4 through 6.

The graphs in FIGS. 8 and 9 illustrate why the present invention has advantages over the prior art. The dotted lines 20 show the actual continuous image intensity across the pixels, while the gray bars 22 denote the discrete intensities that would be generated by the individual pixels. Note that the center five pixels of FIG. 8 (prior art), if taken by themselves, give no clue about the precise location of the full image. That is, they contain no information about the sub-pixel location of the center of the image. They only provide the gross information that the those pixels lie somewhere within the image. It is the pixels containing the edge of the image—where the pixel-to-pixel intensity significantly changes and thus has higher gradient—which contain information about where (the edge of) the image lies and thereby where (the centroid of) the image lies.

In contrast, FIG. 9 graphs a possible plot of the intensity of a line cutting across the specially shaped image formed by the apertures of FIG. 4 through 6. The line might be a horizontal row of pixels cutting across the lower portion of the image, say halfway between the center of the image 20 and the bottom of the image 20. Note that all the image pixels contain non-zero gradients and therefore contribute information toward the sub-pixel location of the centroid of the whole image. Note also that the individual pixel intensities are greater with the same amount of total energy. That means that the signal-to-noise ratio (SNR) is better and that computations based thereon will be more accurate. Neither image energy nor pixel information is “wasted”.

Although it reduces the amount of energy gathered, an alternative embodiment need not use lenses at all. A small version of an aperture 12 like one in FIGS. 4 through 6 could replace the tiny circular hole of a pin-hole type camera. The transverse width of the lineal parts of the aperture would equal the diameter of a normal pin-hole, but their length would be many times the diameter of the pin-hole. The shape of the image of a point radiator would be similar to that of the aperture 12 (although the sharpness of the image edges will be limited by diffraction). However, the advantage of using a lens rather than pin-hole-like optics is that the lens will allow more of the energy to be directed onto the pixel array than without a lens, because the aperture can be many times larger while producing a similarly shaped and similarly sized image as the pin-hole-like embodiment but much brighter.

In yet another alternative embodiment, in lieu of any nonstandard aperture with a lens system, a similar effect can be accomplished by means of diffractive or holographic filters. Examples of such filters are various kinds of special effect photographic filters (such as “star filters”) or the holograms used with laser pointers to create specialty image shapes such as arrows or cross-hairs. Furthermore, in place of lenses, the diffractive equivalent of a lens (like a Fresnel zone plate) might be used, but modified to produce the nonstandard images required by the present invention.

If a lens-like focusing system is employed, it must intentionally blur the image somewhat—otherwise the non-standard aperture would do nothing much different than a circular aperture would—at least for radiators at the distance at which the image is in focus. In other words, without an intentional blue, the lens could still focus a point source to a tiny (circular, perhaps diffraction limited) image spot regardless of the aperture shape. This would not allow the aperture to do its work of shaping the image. Therefore, we desire that the image be somewhat poorly focused over the entire working volume. This implies that a relatively poor quality single-element lens might be employed (although that might worsen the overall non-linearity of the optics, which would then need even more spatial compensation by calibration software). Furthermore, we would prefer that the blurring to be uniform over the whole field of view. Therefore, a preferable method would use an ordinarily well-designed multi-element lens system, but would place a “blurring filter” in front of the lens. The filter could be similar to the softening filter used for photographic portraiture (essentially a very slightly frosted glass window). Alternatively a bi-directional diffraction grating could be used, but rather than a true blur it would generate “dotted” lines of repeated images.

A more sophisticated alternative embodiment would use a holographic filter similar to those which create shapes such as cross-hairs for laser pointers. In this case however, the hologram could function in lieu of both the blurring filter and the shaped aperture itself. The hologram would nevertheless be advantageously used in conjunction with an aperture shaped to match the pattern generated by the hologram.

For a point source the blurring optics and the shaped aperture of this invention (or a functionally equivalent diffraction or holographic filter) generate an image consisting of one or more narrow but elongated linear or curved segments. Each segment longitudinally extends over many pixels but transversally is only a couple pixels wide. The width of each segment ideally could approach the diffraction limit and even be narrower than a single pixel. In that situation, we would be wise to insure that the longitudinal direction of each segment is not exactly parallel to the rows, the columns, or the diagonals of the pixel array. This will insure that a segment of the image is can never be “lost” entirely within a single row or column and thus provide no information regarding subpixel location. (The apertures of FIGS. 5 and 6 would prevent this. Note that the transparent annulus of FIG. 5, although circular, is not a conventional circular aperture. The annular aperture would map a point source to a narrow ring of light that still transects many pixels and fulfills our requirements. It avoids the above problem, but could require correlation kernels of more than one size—see below.)

In any case, the whole image on the pixel array will be somewhat blurred, but clear enough for the purposes of aiming the camera system at the field of view or of determining whether the point radiator(s) can be seen. Details and edges of most non-point-like radiators of energy may simply appear fuzzy, while point radiators will appear as a shape resembling the shape of the aperture.

In contrast to a coded aperture system, the present system requires much less computation. A coded aperture image generally requires a much larger correlation kernel applied over the whole pixel array 16 of the camera to create a humanly recognizable image or even simply to locate the image(s) of the point energy radiator(s) on the pixel array. In contrast, the present invention would allow a system to find the radiator's image more directly and faster—especially if the well-known background subtraction technique is used. (Background subtraction is a known technique, in which the data from full pixel array 16 of the camera is saved while all the energy radiators are turned off temporarily or moved outside the field of view, and thereafter the saved data is then subtracted from the pixel data taken when at least one radiator is turned on. The locations of the images 20 of the radiators are where there are contiguous pixels with large differential values greater than some threshold within the background-subtracted pixel array.)

One may view the present invention as a compromise between a conventional video system and a full-blown coded aperture system. However, the goal is not to form the best final focused image, but to form an image of at least one point energy radiator so that its image can more accurately be located to sub-pixel accuracy.

Now the operation of the preferred embodiment of the present invention will be described as it relates to the improvement in a system which measures the location of at least one point-like radiator using a camera comprising an array of pixels. This description will not include the details of computing the location of the radiator within a 3-D coordinate system from the sub-pixel location of the image 20 of the radiator within two or more 2-D cameras. Such knowledge is well known in the field of photographic and video metrology. For example, the mathematics and techniques of the following publications are incorporated by reference:
(1) Chester Slama (editor), Manual of Photogrammetry, Fourth Edition, American Society of Photogrammetry, Falls Church, Va.
(2) A. M. Coblentz, Robin E. Herron, Biostereometrics '85, Dec. 3-6, 1985 Stereometric Measurement System for Quantification of Object Forms, P. Fischer, F. Mesqui, F. Kaeser.
(3) Robert P. Burton, Ivan E. Sutherland, Twinkle Box-A Three Dimensional Computer Input Device, May 6-10, 1974, AFIPS Conference Proceedings vol. 43.
(4) Henry Fuchs, Joe W. Duran, Brian W. Johnson, Zvi. M. Kedem, Acquisition & Modeling of Human Body Form Data, SPIE vol. 166, July 1978.
(5) V. Macellari, CoSTEL: a Computer Peripheral Remote Sensing Device for 3-Dimensional Monitoring of Human Motion, May 1983.
(6) F. Mesqui, F. Kaeser, P. Fischer, Real-Time, Noninvasive Recording & Three-Dimensional Display of the Functional Movements of an Arbitrary Mandible Point, SPIE vol. 602 Biostereometrics, December 1985.
(7) Roger Y. Tsai, “A Versatile Camera Calibration Technique for High-Accuracy 3D Machine Vision Metrology Using Off-the-Shelf TV Cameras and Lenses”, IEEE Journal of Robotics and Automation, Vol. RA-3, number 4, August 1987.

Although not essential, we assume that a “background” copy of the intensities of the pixels of the full pixel array (scene) is saved while the radiators of energy are extinguished or not present in the field of view. This might be done once and for all at the beginning of operation, if little in the scene (the background) except the presence or location of the energy radiators changes. Alternatively, the background copy might be updated frequently, such as several times per second, if parts of the whole scene other than the radiators are in motion. Then, every time the full pixel array's intensities are accessed thereafter in order to locate the images of the radiators, the saved background array values are subtracted, pixel-by-pixel.

The technique of background subtraction simplifies the detection and localization of the image of each radiator present in the field of view of the camera. Besides that, the technique helps remove the bias of the extraneous, ambient illumination of the scene and cancels out any systematic constant bias in the output of each pixel. A well-known “thresholding” technique would find all contiguous pixels with background-subtracted intensities over some threshold value. Their centroid could then serve as an estimate of the location of the image. Given that estimate, a correlation kernel based on the expected or ideal image of a point radiator would be used locally in the area around the estimate to compute the correlation between the background-subtracted image and the actual image. The centroid of the resulting correlation function would provide a reasonably good and easy-to-compute sub-pixel location for the center of the actual continuous image on the array of discrete pixels.

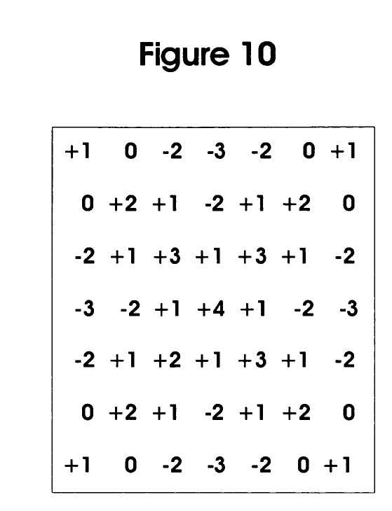

FIG. 10 depicts a 7 by 7 element correlation kernel that might be used in conjunction with the aperture 12 of FIGS. 4 and 7. Obviously the exact size of the kernel would need to match the size (in pixels) of the image cast by a particular such aperture. A small correlation kernel like that in FIG. 10 would be useful for finding the approximate location of the image to the nearest pixel, while one as large or larger than the full image (say 21 by 21 elements) would be preferable for generating the correlation data to feed into the centroid computation. (Details about 2-dimensional correlation filters are covered in many textbooks about machine vision and image processing.)

An alternative sub-pixel location estimation function could be used in lieu of a centroid on the output of the correlation: such as the apex of a best-fit (least-squares) bi-variant quadratic or a best-fit 2-dimensional normal distribution which fits the output of the discrete correlation function. In the case of certain aperture shapes, other specific techniques could be used. For example, in the case of the apertures of FIGS. 4 and 6, a linear regression computation could find the best-fit straight line equation for the centerline of each lineal part of the image. The 2-dimensional intersection (common solution) of the lines (equations) would be used as the image location on the pixel array. In the case of the aperture of FIG. 5, the computation could match the image to the circle that most closely matches it.

Note that the correlation computation in effect filters the image in a way that reconstructs and sharpens the image 20. To some degree it can reverse the blurring and recover the focused image—particularly for the image of each point source of energy. However, in this process, and especially together with the centroid calculation, the image location is determined more accurately to sub-pixel precision than if one simply computed the centroid of a sharply focused image or a conventionally defocused image.

While this invention is described above with reference to a preferred embodiment, anyone skilled in the art can readily visualize alternative embodiments of this invention. Therefore, the scope and content of this invention are not limited by the foregoing description. Rather, the scope and content are to be delineated by the following claims.

1. An improvement in a system for determining the location of at least one point-like radiator of energy in a coordinate system by sensing the radiator using at least one camera containing an array of photosensitive pixels, in which the pixel location of the image of the radiator is determined, so that a radiator location computing means can calculate the location of the radiator itself within the coordinate system from the image location or locations, where the improved system comprises
at least one said point-like energy radiator;
at least one said camera comprising
an image forming means, an image reshaping means, and a pixel array,
wherein each pixel array is an array of energy sensitive detectors;
an image processing means to compute the location of the image of the radiator on each pixel array by identifying the center or some other reference point on the image to a precision of smaller than the size of each pixel; and
said radiator location computing means to calculate the location of the radiator in the coordinate system, given the subpixel location of each image and a calibration function mapping said radiator image locations to the radiator location.

2. The system of claim 1, wherein said energy is visible light or is infrared light.

3. The system of claim 1, wherein said radiator is a light-emitting diode, commonly known as an LED.

4. The system of claim 1, wherein said radiator is a retro-reflector, which reflects energy back toward the sensor from a source of said energy near the line of sight of each said sensor.

5. The system of claim 1, wherein said image forming means is a system comprising at least one lens.

6. The system of claim 1, wherein said image forming means employs diffractive optics.

7. The system of claim 1, wherein said image forming means is the aperture itself acting in the manner of the pinhole of a pinhole camera, but where the aperture is not an approximation of a single circular transparent disc.

8. The system of claim 1, wherein said image reshaping means is a diffractive filter, of which a holographic filter is a special complex example.

9. The system of claim 1, wherein said image reshaping means is a lens system and aperture designed to introduce a small amount of distortion to reshape a tiny circular spot image into an image which increases the perimeter-to-area ratio of the image by at least 50% and spreads the image over more than 4 non-collinear pixels.

10. The system of claim 1, wherein said image reshaping means is a noncircular aperture.

11. The system of claim 10, wherein the aperture comprises at least one energy transparent area within an energy opaque mask.

12. The system of claim 11, wherein at least one transparent area has a total perimeter-to-area ratio which is at least 50% greater than that of a circular disc.

13. The system of claim 1, wherein said image reshaping means is a diffraction grating.

14. The system of claim 1, wherein said image reshaping means is a holographic filter.

15. The system of claim 1, wherein each pixel array is a charge-coupled device commonly known as a CCD.

16. The system of claim 1, wherein said image processing means employs a correlation function matched to the expected shape of the image of said radiator as imaged by the sensor.

17. The system of claim 1, wherein said image processing means uses some best-fit criterion to map a movable and scalable geometrical entity onto the image on the pixel array, where the entity possesses at least a reference point, which point then defines the location of the image on the pixel array.

18. The system of claim 18, wherein the geometrical entity is a straight line segment.

19. The system of claim 18, wherein the geometrical entity is all or part of a conic section curve.

20. The system of claim 18, wherein the geometrical entity is a polynomial arc.

21. The system of claim 1, wherein the image processing means is an electronic microprocessor.

22. The system of claim 1, wherein said radiator location computing means is an electronic microprocessor.

23. An improvement in a location measurement system, which system comprises
a coordinate system;
at least one point-like radiator of energy within the coordinate system;
at least one energy sensor which forms an image of at least one radiator;
a image processor to find said image in the sensor and to calculate the location of said image in the sensor; and
a radiator location computer to calculate the location of each radiator relative to the coordinate system, given at least one image location and a calibration function mapping at least one said image location to a coordinate set representing the location in the coordinate system;
where said improvement comprises
an image reshaping means in at least one said sensor, such that the image always covers at least 4 non-collinear pixels and the reshaping increases the number of pixels containing edges of the reshaped image compared to the original image by at least 50%;
such that the image processor is adapted to process a reshaped image generated from the original image by the image reshaping means.

24. The system of claim 23, wherein said energy is visible light or is infrared light.

25. The system of claim 23, wherein said radiator is a light-emitting diode, commonly known as an LED.

26. The system of claim 23, wherein said radiator is a retro-reflector, which reflects energy back toward the sensor from an energy radiator near the line of sight of each said sensor.

27. The system of claim 23, wherein said sensor includes at least one lens.

28. The system of claim 23, wherein said sensor includes diffractive optics.

29. The system of claim 23, wherein said sensor includes an aperture acting in the manner of the pinhole of a pinhole camera, but the aperture is not a single circular disc.

30. The system of claim 23, wherein said image reshaping means is a diffractive filter.

31. The system of claim 30, wherein said filter is a holographic filter.

32. The system of claim 23, wherein said image reshaping means is a lens system intended to introduce a small amount of distortion in order to reshape a tiny circular spot image into an image which increases the perimeter-to-area ratio of the image by at least 50% and spreads the image over at least 4 non-collinear pixels.

33. The system of claim 23, wherein said image reshaping means is an aperture.

34. The system of claim 33, wherein the aperture comprises at least one energy transparent area within an energy opaque mask.

35. The system of claim 34, wherein at least one transparent area has a total perimeter-to-area ratio which is at least 50% greater than that of a circular disc.

36. The system of claim 23, wherein said image reshaping means is a diffraction grating.

37. The system of claim 23, wherein said image reshaping means is a holographic filter.

38. The system of claim 23, wherein each pixel array is a charge-coupled device commonly known as a CCD.

39. The system of claim 23, wherein said image processing means uses a correlation function matched to the expected shape of the image of said radiator as imaged by the sensor.

40. The system of claim 23, wherein said image processing means uses some best-fit criterion to map a movable and scalable geometrical entity onto the image on the pixel array, where the entity possesses at least a reference point, which point then defines the location of the image on the pixel array.

41. The system of claim 40, wherein the geometrical entity is a straight line segment.

42. The system of claim 40, wherein the geometrical entity is all or part of a conic section curve.

43. The system of claim 40, wherein the geometrical entity is a polynomial arc.

44. The system of claim 23, wherein the image processor is an electronic microprocessor.

45. The system of claim 23, wherein said radiator location computer means is an electronic microprocessor.

46. A process for determining the location of a point-like radiator of energy in a coordinate space by forming the image of the radiator in at least one sensor, precisely determining the location of the image of the radiator therein, and calculating the location of the radiator itself within the coordinate system from at least one such image location, where the process comprises
placing a point-like energy radiator in said coordinate space;
forming an image in at least one said sensor
reshaping at least one such image
processing the image to determine its location in the sensor by identifying the center or some other reference point on the image to a precision of smaller than the size of each pixel; and
computing said radiator location coordinates describing the location of the radiator in the coordinate space, when given the subpixel location of sufficient images and given a calibration function mapping the image locations of the sufficient images to the radiator location.
